(19) United States
(12) Patent Application Publication
(10) Pub. No.: US 2010/0279520 A1
(43) Pub. Date: Nov. 4, 2010

(54) STORAGE CARD SOCKET FOR BIDIRECTIONAL ELECTRICAL CONNECTION

(76) Inventor: Chou Hsien Tsai, SinJhuang City (TW)

Correspondence Address: PRO-TECHTOR INTERNATIONAL SERVICES, 20775 NORADA CT., SARATOGA, CA, 95070, US

(21) Appl. No.: 12/770,146

(22) Filed: Apr. 29, 2010

(30) Foreign Application Priority Data
Apr. 30, 2009 (TW) 098207364
May 15, 2009 (TW) 098208541

(51) Int. Cl. H01R 12/18; H01R 24/00

(52) U.S. Cl. 439/62; 439/630

(57) ABSTRACT

A storage card socket for a bidirectional electrical connection includes a plastic base, a connection slot, a metal casing, at least one row of lower contacts and at least one row of upper contacts. The connection slot disposed at a front end of the plastic base has an inserting port and opposite top and bottom surfaces, and may be connected to a plug of a storage card. The metal casing covers the plastic base and has an opening corresponding to the inserting port of the connection slot. The lower contacts are separately arranged in the connection slot and are directed to the top surface of the connection slot. The upper contacts are separately arranged in the connection slot and are directed to the bottom surface of the connection slot.

### BACKGROUND OF THE INVENTION

1. Field of the Invention

The invention relates in general to an electrical connector, and more particularly to a storage card socket for a bidirectional electrical connection.

2. Related Art

The most popular signal transmission specification in the current computer apparatus is the universal serial bus (USB). The connector socket and the transmission cable satisfying this specification make the peripheral apparatus, such as a mouse, a storage card, a keyboard or the like, connected to the computer may be plugged and played.

At present, the popular mobile disk also pertains to a storage card. The plug of the storage card may have a metal casing or have no metal casing.

FIG. 1 is a three-view drawing showing a storage card 20. One end of the storage card 20 is formed with a plug 21 having the USB 2.0 connection interface and no metal casing. One surface of the plug 21 is formed with four separately arranged connection terminals 22, which cannot be moved elastically.

The storage card 20 may be electrically connected to a USB socket. Because the current USB socket has a tongue having one surface formed with one row of four connection terminals, the storage card 20 has to be inserted in a correct direction so that the connection terminals may be aligned to establish the electrical connection.

In order to ensure that the electrical connection can be made when the storage card 20 is inserted, the mistake-proof design is adopted. That is, the plug of the storage card 20 cannot be oppositely inserted, and the user has to flip the plug so that the plug can be correctly inserted and the electrical connection can be ensured.

So, the user usually has to insert the plug twice because the user randomly inserts the plug into the slot.

Furthermore, if a socket for the bidirectional electrical connection is designed, an additional set of pin portions has to be added. In this case, the socket cannot fit with the pin holes of the currently used mainboard and cannot be bonded to the mainboard.

FIG. 2 is a three-view drawing showing another storage card 25. One end of the storage card 25 is formed with a plug 26 having the shape the same as that of the plug 21 of the storage card 20. However, one surface of the plug 26 is formed with nine separately arranged connection terminals 27, which cannot be moved elastically.

This storage card 25 does not have the USB 2.0 connection interface, and thus cannot be electrically connected to a USB socket. Instead, a specific connector has to be provided to establish the electrical connection.

### SUMMARY OF THE INVENTION

It is therefore a main object of the invention to provide a storage card socket for a bidirectional electrical connection, wherein a plug of the storage card can be electrically connected to the socket when it is inserted thereto abnormally or normally so that the socket can be conveniently used.

Another object of the invention is to provide a storage card socket for a bidirectional electrical connection, wherein two storage cards having different connection interfaces may be inserted into the socket for the electrical connection, and the socket may be used in a diversified manner.

Still another object of the invention is to provide a storage card socket for a bidirectional electrical connection, wherein a plug of the storage card can be electrically connected to the socket when it is inserted thereto abnormally or normally, and the socket has pin portions the same as another socket for a unidirectional connection.

Yet still another object of the invention is to provide a storage card socket for a bidirectional electrical connection, wherein two storage cards having different connection interfaces, widths and thicknesses may be inserted into the socket for the electrical connection so that the socket may be used in a diversified manner.

The invention achieves the above-identified objects by providing a storage card socket for a bidirectional electrical connection. The socket includes a plastic base, a connection slot, a metal casing, at least one row of lower contacts and at least one row of upper contacts. The connection slot is disposed at a front end of the plastic base, has an inserting port and opposite top and bottom surfaces, and may be connected to a plug of a storage card. The metal casing covers the plastic base and has an opening corresponding to the inserting port of the connection slot. The at least one row of lower contacts are separately arranged in the connection slot. The lower contacts are directed to the top surface of the connection slot. The at least one row of upper contacts are separately arranged in the connection slot. The upper contacts are directed to the bottom surface of the connection slot.

The at least one row of upper contacts and the at least one row of lower contacts pertain to the same connection interface. The number of the row of upper contacts corresponds to the number of the row of lower contacts. Thus, the plug of the storage card can be electrically connected to the socket when it is inserted thereto abnormally or normally so that the socket can be conveniently used.

The at least one row of upper contacts and the at least one row of lower contacts pertain to different connection interfaces so that two storage cards with different connection interfaces may be inserted for the electrical connection and the socket may be used in the diversified manner.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a three-view drawing showing a conventional storage card.

FIG. 2 is a three-view drawing showing another storage card.

FIG. 3 is a pictorially exploded view showing a first embodiment of the invention.

FIG. 4 is a cross-sectional side view showing the first embodiment of the invention.

FIG. 5 is a front view showing the first embodiment of the invention.

FIGS. 6 and 7 show used states of the first embodiment of the invention when a storage card is inserted.

FIG. 8 is a pictorially exploded view showing a second embodiment of the invention.

FIG. 9 is a cross-sectional side view showing the second embodiment of the invention.

FIG. 10 is a schematic illustration showing traces of a circuit board according to the second embodiment of the invention.

FIG. 11 is a pictorially exploded view showing a third embodiment of the invention.

FIG. 12 is a pictorially assembled view showing the third embodiment of the invention.

FIG. 13 is a cross-sectional side view showing the third embodiment of the invention.

FIGS. 14 and 15 show used states of the third embodiment of the invention when the storage card is inserted.

FIG. 16 is a pictorially exploded view showing a fourth embodiment of the invention.

FIG. 17 is a cross-sectional side view showing the fourth embodiment of the invention.

FIG. 18 is a schematic illustration showing traces of a circuit board according to the fourth embodiment of the invention.

FIG. 19 is a pictorially exploded view showing a fifth embodiment of the invention.

FIG. 20 is a pictorially assembled view showing upper and lower circuit boards, terminals and pin portions according to the fifth embodiment of the invention.

FIG. 21 is a cross-sectional side view showing the fifth embodiment of the invention.

FIG. 22 is a cross-sectional side view showing a sixth embodiment of the invention.

FIG. 23 is a front view showing the sixth embodiment of the invention.

FIG. 24 is a cross-sectional top view showing the sixth embodiment of the invention.

FIG. 25 is a cross-sectional bottom view showing the sixth embodiment of the invention.

FIG. 26 shows the used state of the sixth embodiment of the invention when a storage card is inserted.

FIG. 27 shows the used state of the sixth embodiment of the invention when another storage card is inserted.

FIG. 28 is a front view showing a seventh embodiment of the invention.

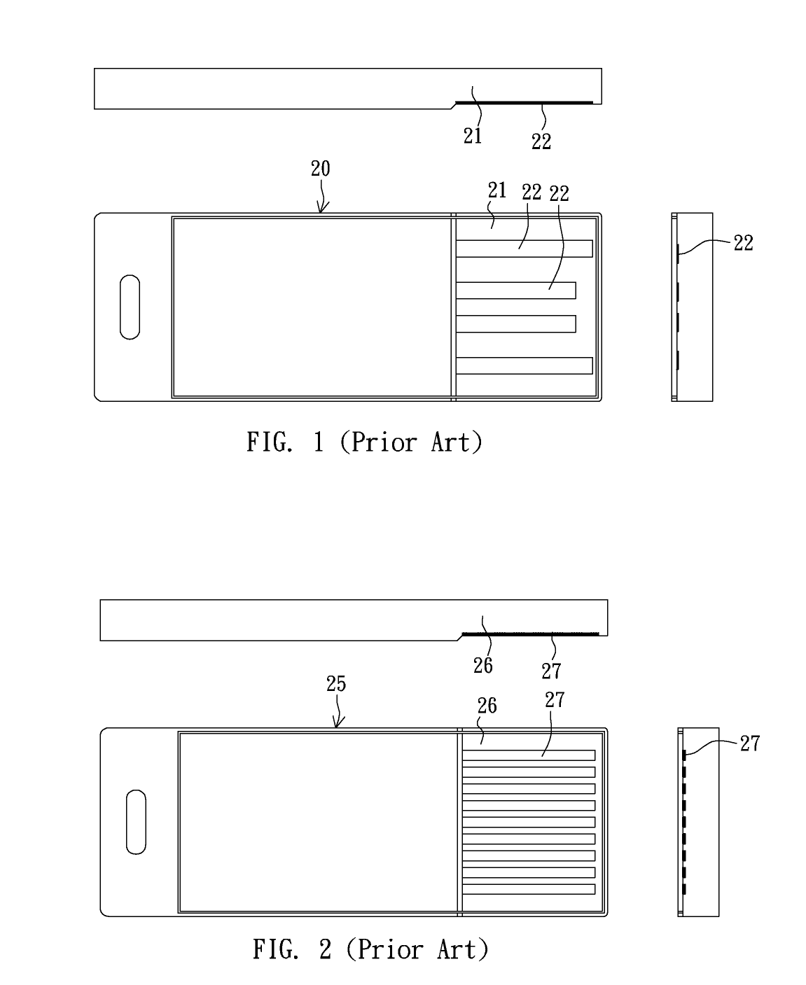

### DETAILED DESCRIPTION OF THE INVENTION

The present invention will be apparent from the following detailed description, which proceeds with reference to the accompanying drawings, wherein the same references relate to the same elements.

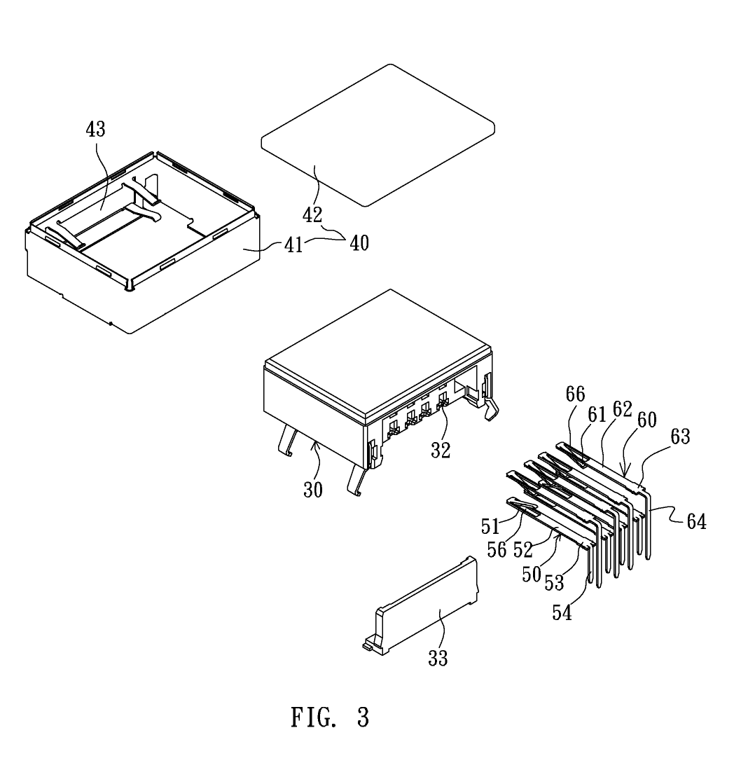

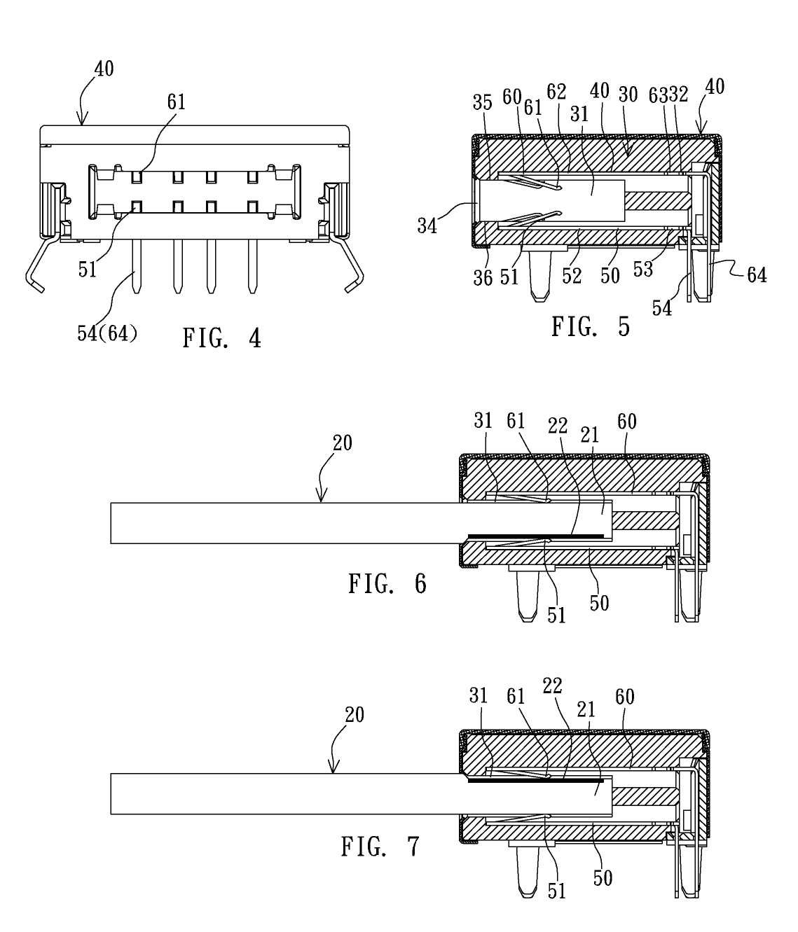

Referring to FIGS. 3 to 5, the first embodiment of the invention is directed to a USB 2.0 storage card socket including a plastic base 30, a metal casing 40, one row of first lower terminals 50 and one row of first upper terminals 60.

The plastic base 30 is integrally formed with a connection slot 31, and the rear end of the plastic base 30 has two rows of terminal slots 32. In addition, a rear cover 33 is provided to cover the plastic base 30 from bottom to top. The connection slot 31 is disposed in the front section of the plastic base 30, and the plastic base 30 has an inserting port 34 and opposite top and bottom surfaces 35 and 36. The connection slot 31 may be connected to a plug of a storage card.

The metal casing 40 covers the plastic base 30 and has a main body 41 and an upper cover 42 covering the main body 41. The main body has front, rear, left and right surfaces. The front surface of the main body is formed with an opening 43 corresponding to the inserting port 34 of the connection slot 31.

The one row of four first lower terminals 50 are separately arranged on and fixed to the plastic base 30. The first lower terminal 50 is integrally formed with a lower contact 51, an extension 52, a fixing portion 53 and a pin portion 54. The fixing portion 53 is fixed to the terminal slot 32 of the plastic base 30. The extension 52 is in surface contact with the plastic base 30 below the connection slot 31 and extends frontward. The plate surface of the front section of the extension 52 is formed with a notch 56 larger than the plate surface of the lower contact 51. One end of the lower contact 51 is connected to the extension 52 and gradually projects beyond the plate surface of the extension 52 from front to rear, and extends to the other end being open and serving as a free end. Thus, the lower contact 51 projects toward a top surface 35 of the connection slot 31 and may be elastically moved up and down. The pin portion 54 extends out of the plastic base 30.

The one row of four first upper terminals 60 are separately arranged on and fixed to the plastic base 30. The first upper terminal 60 is integrally formed with an upper contact 61, an extension 62, a fixing portion 63 and a pin portion 64. The fixing portion 63 is fixed to the terminal slot 32 of the plastic base 30, and the extension 62 is in surface contact with the plastic base 30 above the connection slot 31 and extends frontward. The plate surface of the front section of the extension 62 is formed with a notch 66 lager than the plate surface of the upper contact 61. One end of the upper contact 61 is connected to the extension 62 and gradually projects beyond the plate surface of the extension 62 from front to rear and extends to the other end being open and serving as a free end. Thus, the upper contact 61 projects toward a bottom surface 36 of the connection slot 31 and may be elastically moved up and down. The pin portion 64 extends out of the plastic base 30. The number of the row of upper contacts 61 corresponds to or is the same as the number of the row of lower contacts 51 so that the upper contacts 61 and the lower contacts pertain to the same connection interface.

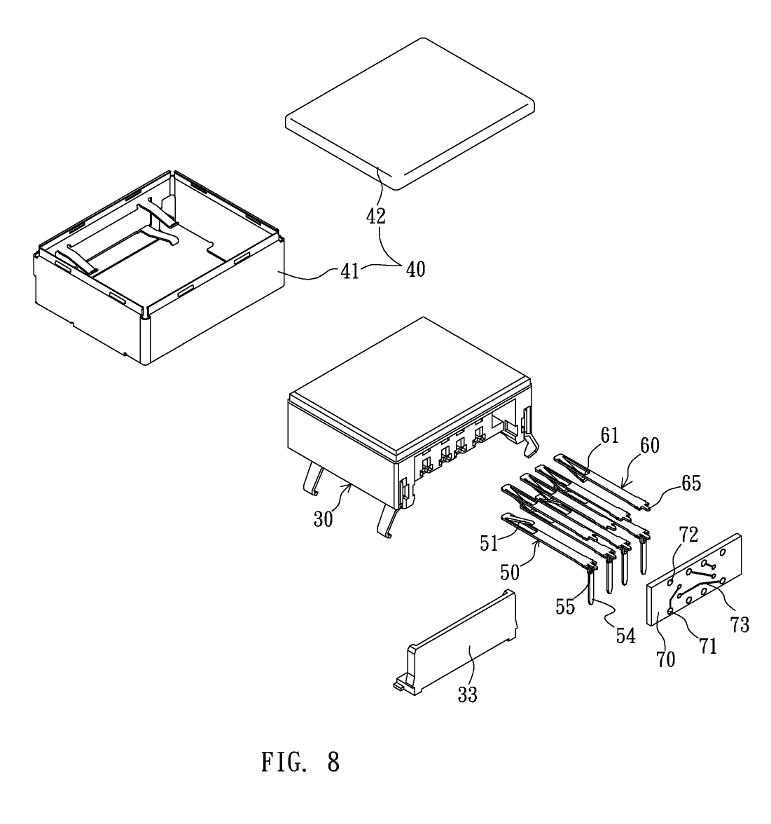

According to the above-mentioned structure, as shown in FIG. 6, when a connection terminal 22 of a plug 21 of a storage card 20 is downwardly inserted into the connection slot 31, the connection terminal 22 is electrically connected to the lower contact 51 of the first lower terminal 50. As shown in FIG. 7, when the connection terminal 22 of the plug 21 of the storage card 20 is upwardly inserted into the connection slot 31, the connection terminal 22 is electrically connected to the upper contact 61 of the first upper terminal 60 so that the storage card 20 may be bidirectionally inserted for the electrical connection and the user can randomly insert the storage card to establish the electrical connection in an convenient manner.

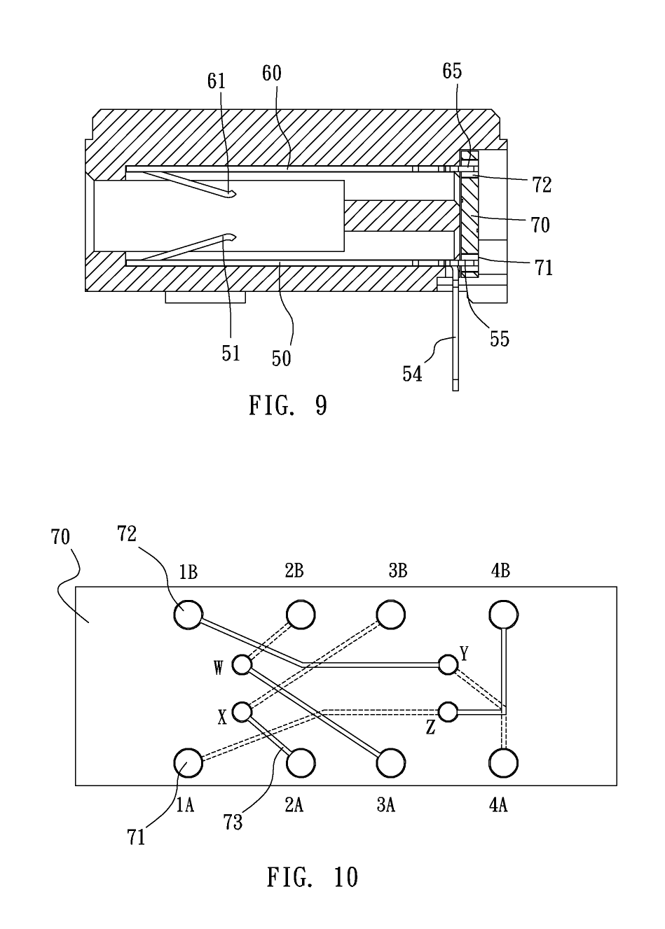

As shown in FIGS. 8 to 10, the second embodiment of the invention is almost the same as the first embodiment except that the embodiment further has a circuit board 70 and the one row of first upper terminals 60 do not have the pin portions. The circuit board 70 has four lower vias 71 sequentially arranged and numbered as 1A to 4A, and four upper vias 72 sequentially arranged and numbered as 1B to 4B. Each of the lower vias 71 is electrically connected to one upper via 72 through the trace 73. As shown in FIG. 10, since each first lower terminal 50 is sequentially electrically connected to a first lower terminal 60, which is oppositely arranged with respect to the first lower terminal 50. So, the same signal output may be obtained through one row of pin portions 54. So, this embodiment can achieve the bidirectional electrical connection but only needs one set of four pin portions same as the storage card socket for the unidirectional connection so that it may be connected to a mainboard having four pin holes.

The depicted dashed line represents the trace on the other side of the circuit board, and the cascaded paths are 1A-Z-4B, 2A-X-3B, 3A-W-2B and 4A-Y-1B. The rear end of the fixing portion of each of the first lower terminals 50 is formed with a projection 55 fit with the lower via 71 for the electrical connection. The rear end of the fixing portion of each of the first upper terminals 60 is formed with a projection 65 fit with the upper via 72 for the electrical connection.

According to the cascaded connection of the circuit board, each first lower terminal 50 may be sequentially electrically connected to the oppositely arranged first upper terminal 60, and the terminals 50 and 60 share the pin portion 54 extending out of the plastic base. That is, the first one of the first lower terminals 50 (1A) is electrically connected to the last one of the first upper terminals 60 (4B), and the second one of the first lower terminals 50 (2A) is electrically connected to the last second one of the first upper terminal 60 (3B), and so on.

According to the above-mentioned structure, the connection terminal is connected to the lower contact 51 of the first lower terminal 50 when the connection terminal of the storage card is downwardly inserted for the connection, and the connection terminal is connected to the upper contact 61 of the first upper terminal 60 when the connection terminal of the storage card is upwardly inserted for the connection. Because each first lower terminal 50 is sequentially electrically connected to the first upper terminal 60, which is oppositely arranged with respect to the terminal 50, the same signal output may be obtained through the one row of pin portions 54. So, this embodiment can achieve the bidirectional electrical connection but only needs one set of four pin portions same as the storage card socket for the unidirectional connection so that it may be connected to a mainboard having four pin holes.

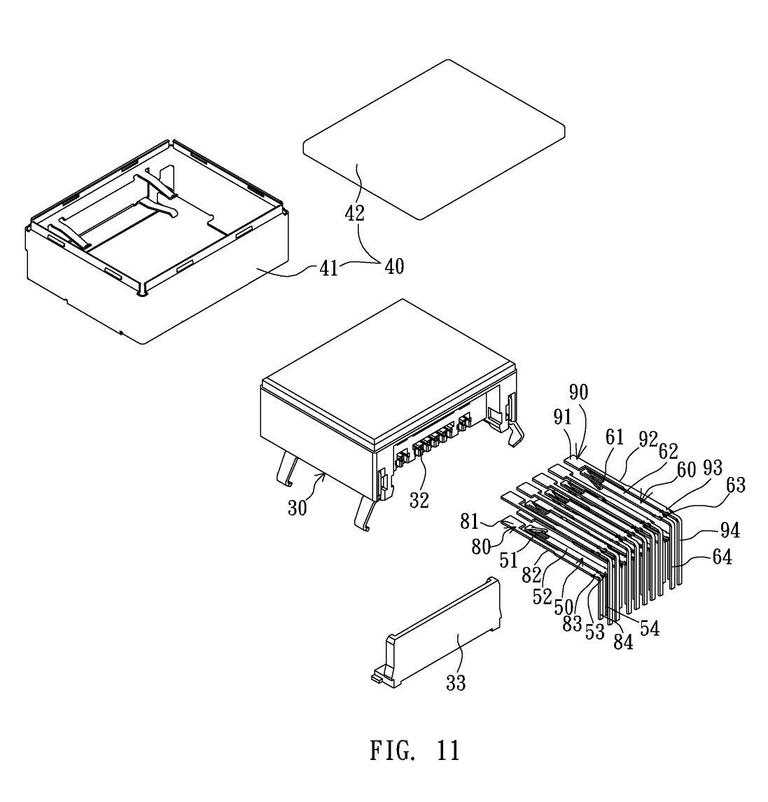

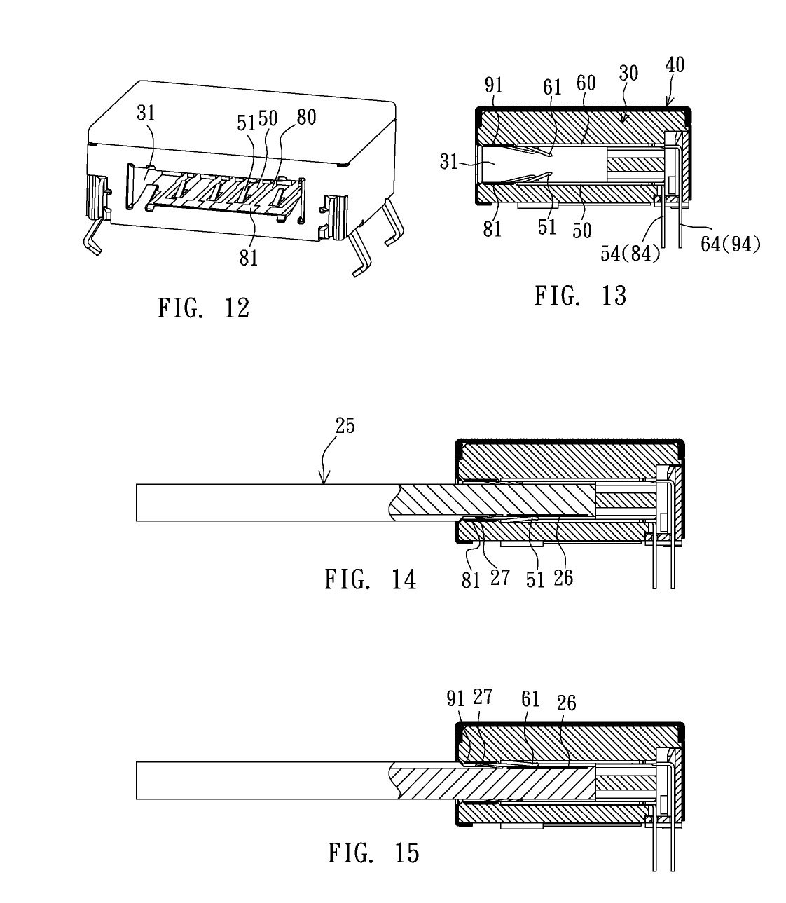

As shown in FIGS. 11 to 13, the third embodiment of the invention relates to the USB 3.0 storage card socket and is almost the same as the first embodiment except that this embodiment further has one row of five second lower terminals 80 and one row of five second upper terminals 90. The row of first lower terminals 50 and the row of second lower terminals 80 are formed by pressing the same metal plate. The one row of first upper terminals 60 and the row of second upper terminals 90 are formed by pressing the same metal plate.

The second lower terminal 80 is integrally formed with a lower contact 81, an extension 82, a fixing portion 83 and a pin portion 84. The fixing portion 83 is fixed to the terminal slot 32 of the plastic base 30. The extension 82 is in surface contact with the plastic base 30 below the connection slot 31 and extends frontward. The lower contact 81 is connected to the front end of the extension 82 and is in surface contact with the plastic base 30. The lower contact 81 is disposed in front of the lower contact 51 of the first lower terminal 50.

The second upper terminal 90 is integrally formed with an upper contact 91, an extension 92, a fixing portion 93 and a pin portion 94. The fixing portion 93 is fixed to the terminal slot 32 of the plastic base 30. The extension 92 is in surface contact with the plastic base 30 above the connection slot 31 and extends frontward. The upper contact 91 is connected to the front end of the extension 92 and is in surface contact with the plastic base 30. The upper contact 91 is disposed in front of the upper contact 61 of the first upper terminal 60.

The number of the row of upper contacts 61 corresponds to or is the same as the number of the row of lower contacts 51 so that the upper contacts 61 and the lower contacts 51 pertain to the same connection interface. The number of the row of upper contacts 91 corresponds to or is the same as the number of the row of lower contacts 81 so that the upper contacts 91 and the lower contacts 81 pertain to the same connection interface.

According to the above-mentioned structure, as shown in FIG. 14, when the two rows of connection terminals 26 and 27 of the plug of the USB 3.0 storage card 25 are downwardly inserted into the connection slot, the connection terminals 26 are electrically connected to the lower contacts 51 of the first lower terminals 50, and the connection terminals 27 are electrically connected to the lower contacts 81 of the second lower terminals 80. As shown in FIG. 15, when the two rows of connection terminals 26 and 27 of the plug of the storage card 25 are upwardly inserted into the connection slot, the connection terminals 26 are electrically connected to the upper contacts 61 of the first upper terminals 60, and the connection terminals 27 are electrically connected to the upper contacts 91 of the second upper terminals 90. So, the USB 3.0 storage card 25 may be bidirectionally inserted thereto for the electrical connection so that the user can randomly insert the USB 3.0 storage card for the electrical connection in a convenient manner.

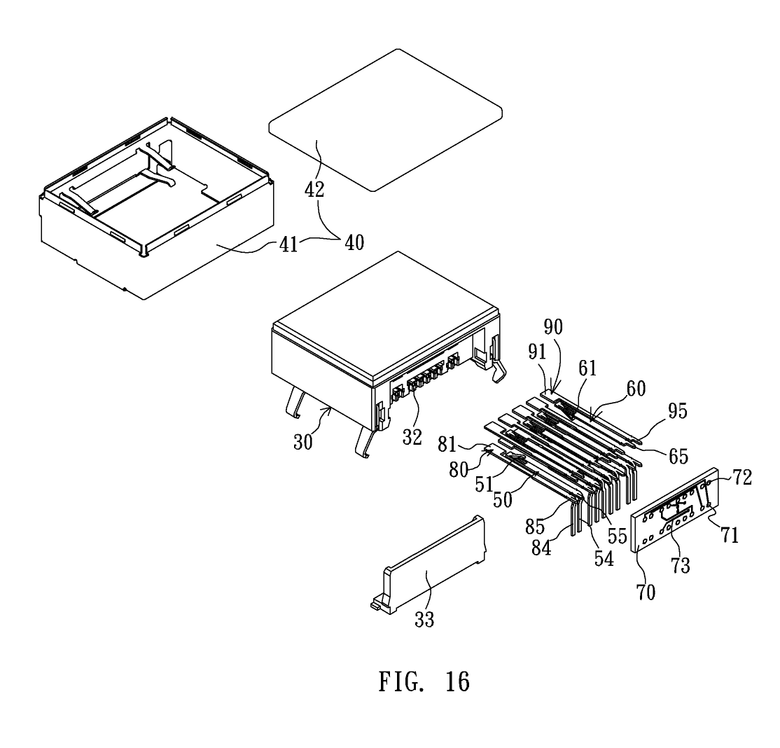

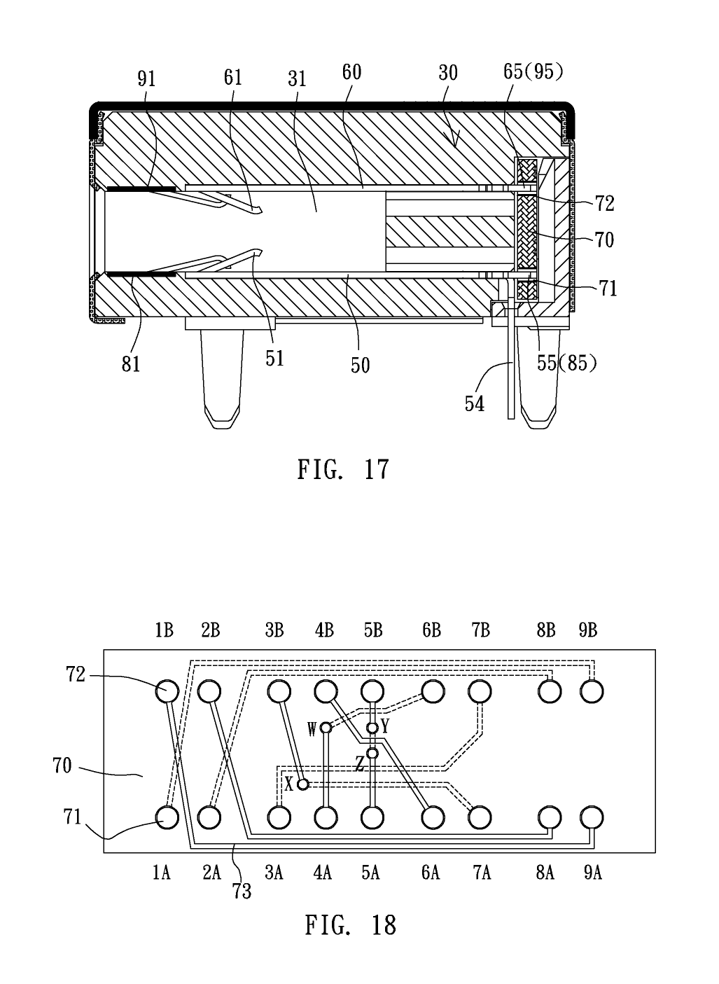

As shown in FIGS. 16 to 18, the fourth embodiment of the invention is almost the same as the third embodiment except that this embodiment further has a circuit board 70 and the two rows of first upper terminals 60 and 90 are not formed with the pin portions. The circuit board 70 has one row of nine lower vias 71 sequentially arranged and numbered as 1A to 9A, and one row of nine upper vias 72 sequentially arranged and numbered as 1B to 9B. Each lower via 71 is electrically connected to the upper via 72 through the trace 73. The dashed line in FIG. 18 represents the trace on the other side of the circuit board, and the cascaded paths are 1A-9B, 2A-8B, 3A-7B, 4A-W-6B, 5A-Z-Y-5B, 6A-4B, 7A-X-3B, 8A-2B and 9A-1B. The rear ends of the fixing portions of the one row of first lower terminals 50 and the one row of second lower terminals 80 are respectively formed with projections 55 and 85 fit with the lower vias 71 for the electrical connection. The rear ends of the fixing portions of the one row of first upper terminals 60 and the one row of second upper terminals 90 are respectively formed with projections 65 and 95 fit with the upper via 72 for the electrical connection.

According to the cascaded paths of the circuit board, each first lower terminal 50 may be sequentially electrically connected to the first upper terminal 60, which is oppositely arranged with respect to the first lower terminal 50, and the terminals 50 and 60 share the pin portion 54 extending out of the plastic base. Each second lower terminal 80 is sequentially electrically connected to the second upper terminal 90, which is oppositely arranged with respect to the second lower terminal 80, and the terminals 80 and 90 share the pin portion 84 extending out of the plastic base.

According to the above-mentioned structure, this embodiment can achieve the bidirectional electrical connection of the USB 3.0 storage card but only needs one set of nine pin portions same as the storage card socket for the unidirectional connection so that it may be connected to a mainboard having nine pin holes.

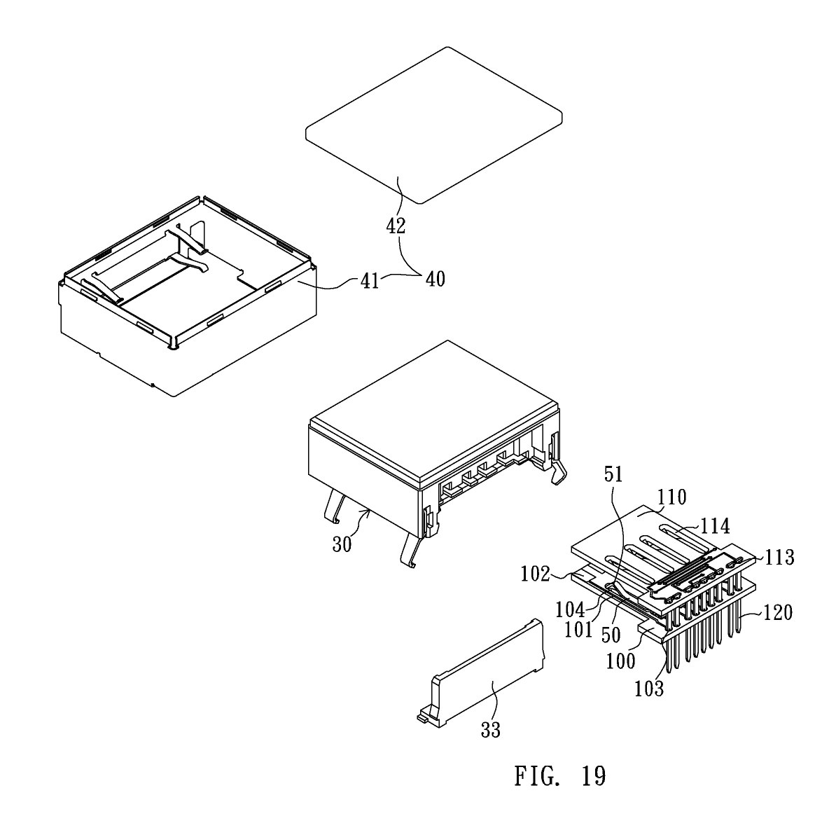

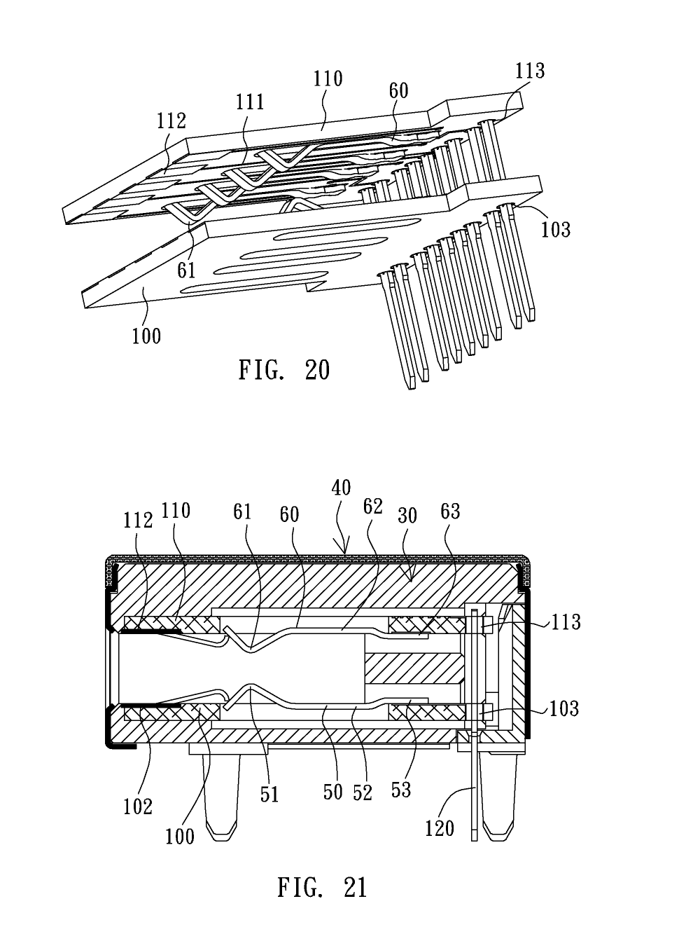

As shown in FIGS. 19 to 21, the fifth embodiment of the invention is a USB 3.0 storage card socket including a plastic base 30, a metal casing 40, one row of first lower terminals 50, one row of first upper terminals 60, a lower circuit board 100, an upper circuit board 110 and one row of pin portions 120.

The plastic base 30 is integrally formed with a connection slot 31, and a rear cover 33 is provided to cover the rear end of the plastic base 30 from bottom to top. The connection slot 31 is disposed on the front section of the plastic base 30 and may be connected to a plug of a storage card.

The metal casing 40 covers the plastic base 30 and has a main body 41 and an upper cover 42 covering the main body 41. The main body has front, rear, left and right surfaces and the front surface of the main body is formed with an opening corresponding to the inserting port of the connection slot 31.

The one row of first lower terminals 50 include four terminals. The first lower terminal 50 is integrally formed with a lower contact 51, an extension 52 and a fixing portion 53. The lower contact 51 is connected to the front end of the extension 52 and projects frontward and upward.

The one row of first upper terminals 60 include four terminals. The first upper terminal 60 is integrally formed with an upper contact 61, an extension 62 and a fixing portion 63. The upper contact 61 is connected to the front end of the extension 62 and projects frontward and downward.

The lower circuit board 100 has five separately arranged first traces 101. The first trace 101 extending to the front section of the lower circuit board 100 is formed with a lower contact 102. Four through slots 104 and four bonding portions are formed between the five first traces 101. The fixing portions 53 of the row of first lower terminals 50 are respectively bonded to the four bonding portions. The lower contact 102 is disposed in front of the lower contact 51 of the first lower terminal 50. The lower contact 51 may be elastically moved in the through slot 104. The rear section of the lower circuit board 100 is formed with nine vias 103. The five first traces 101 and the four first lower terminals 50 are respectively electrically connected to the nine vias 103 through the traces, and the lower circuit board 100 is positioned at the lower section of the plastic base 30.

The upper circuit board 110 has five separately arranged second traces 111. The second trace 111 extending to the front section of the upper circuit board 110 is formed with an upper contact 112. Four through slots 114 and four bonding portions are formed between the five second traces 111. The fixing portions 63 of the row of first upper terminals 60 are respectively bonded to the four bonding portions. The upper contact 112 is disposed in front of the upper contact 61 of the first upper terminal 60. The upper contact 61 may be elastically moved in the through slot 114. The rear section of the upper circuit board 110 is formed with one row of nine vias 113. The five second traces 111 and the four first upper terminals 60 are respectively electrically connected to the nine vias 113 through the traces. The upper circuit board 110 is positioned at the lower section of the plastic base 30. In addition, the upper circuit board 110 is formed with traces so that the five second traces 111 and the four first upper terminals 60 are oppositely arranged and sequentially electrically connected to the nine vias 113.

The row of pin portions 120 include nine pin portions. Each pin portion 120 penetrates through the vias 103 and 113 and is bonded thereto so that the traces of the two rows of lower contacts 51 and 102 and the two rows of upper contacts 61 and 112 are cascaded, and one row of pin portions 120 are shared therebetween.

According to the above-mentioned structure, this embodiment can achieve the bidirectional electrical connection of the USB 3.0 storage card but only needs one set of nine pin portions same as the storage card socket for the unidirectional connection so that it may be connected to a mainboard having nine pin holes.

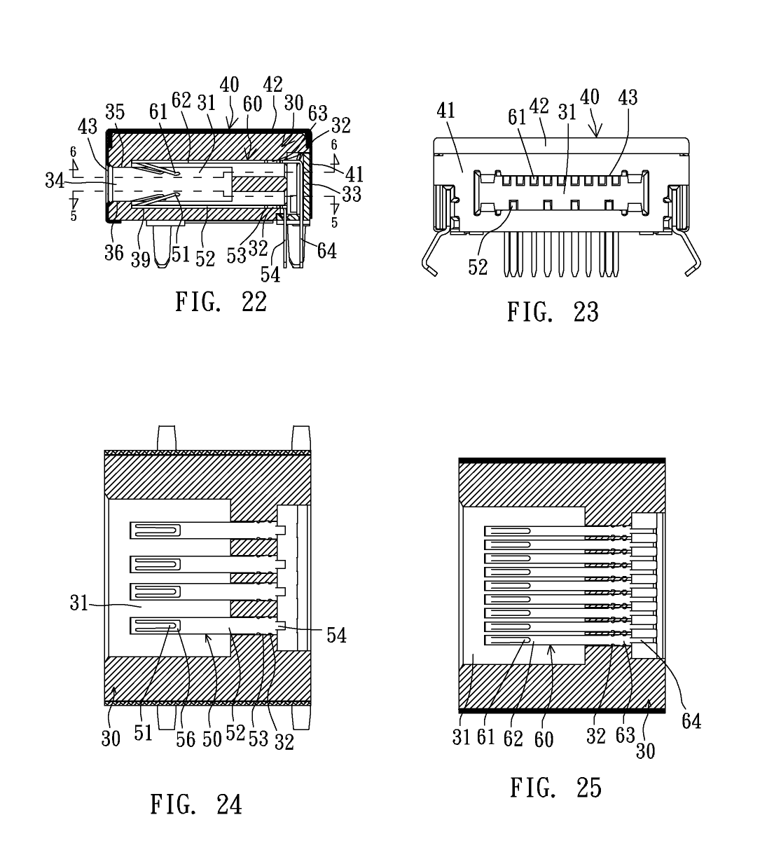

As shown in FIGS. 22 to 25, the sixth embodiment of the invention includes a plastic base 30, a metal casing 40, one row of first lower terminals 50 and one row of first upper terminals 60.

The plastic base 30 is integrally formed with a connection slot 31. The rear end of the plastic base 30 is formed with two rows of terminal slots 32, and a rear cover 33 is provided to cover the rear end of the plastic base 30 from bottom to top. The connection slot 31 is disposed on the front section of the plastic base 30 and has an inserting port 34 and opposite top and bottom surfaces 35 and 36. The connection slot 31 may be connected to a plug of a storage card. Two rows of separately arranged terminal slots 39 are respectively disposed above and below the connection slot 31.

The metal casing 40 covers the plastic base 30 and has a main body 41 and an upper cover 42 covering the main body 41. The main body 41 has front, rear, left and right surfaces, and the front surface of the main body 41 is formed with an opening 43 corresponding to the inserting port 34 of the connection slot 31.

The one row of four first lower terminals 50 are separately arranged on and fixed to the plastic base 30. The lower terminal 50 is integrally formed with a lower contact 51, an extension 52, a fixing portion 53 and a pin portion 54. The extension 52, the fixing portion 53 and the pin portion 54 are connected together from front to rear. The fixing portions 53 are fixed to the lower row of terminal slots 32 of the plastic base 30. The extension 52 is in surface contact with the terminal slot 39 below the connection slot 31 and extends frontward. The plate surface of the front section of the extension 52 is formed with a notch 56 larger than the plate surface of the lower contact 51. One end of the lower contact 51 is connected to the extension 52, gradually projects beyond the plate surface of the extension 52 to the connection slot 31 from front to rear and extends to the other end being open and serving as a free end. When the lower contact 51 is being flattened toward the plate surface of the extension, it is entirely disposed within the notch 56. The lower contact 51 projects toward the top surface 35 of the connection slot 31 and may be elastically moved up and down. The pin portion 54 extends out of the plastic base 30.

The row of nine first upper terminals 60 are separately arranged on and fixed to the plastic base 30. The upper terminal 60 is integrally formed with an upper contact 61, an extension 62, a fixing portion 63 and a pin portion 64. The extension 62, the fixing portion 63 and the pin portion 64 are connected together from front to rear. The fixing portions 63 are fixed to the upper row of terminal slots 32 of the plastic base 30. The extension 62 is in surface contact with the terminal slot 39 above the connection slot 31 and extends frontward. The upper contact 61 is prodded to project beyond the plate surface of the extension 62. One end of the upper contact 61 is connected to the extension 62, gradually projects beyond the plate surface of the extension 62 to the connection slot 31 from front to rear and extends to the other end being open and serving as a free end. The upper contact 61 projects toward the bottom surface 36 of the connection slot 31 and may be elastically moved up and down. The pin portion 64 extends out of the plastic base 30.

The number of the row of upper contacts 61 is different from the number of the row of lower contacts 51 so that the upper contacts 61 and the lower contacts 51 pertain to different connection interfaces.

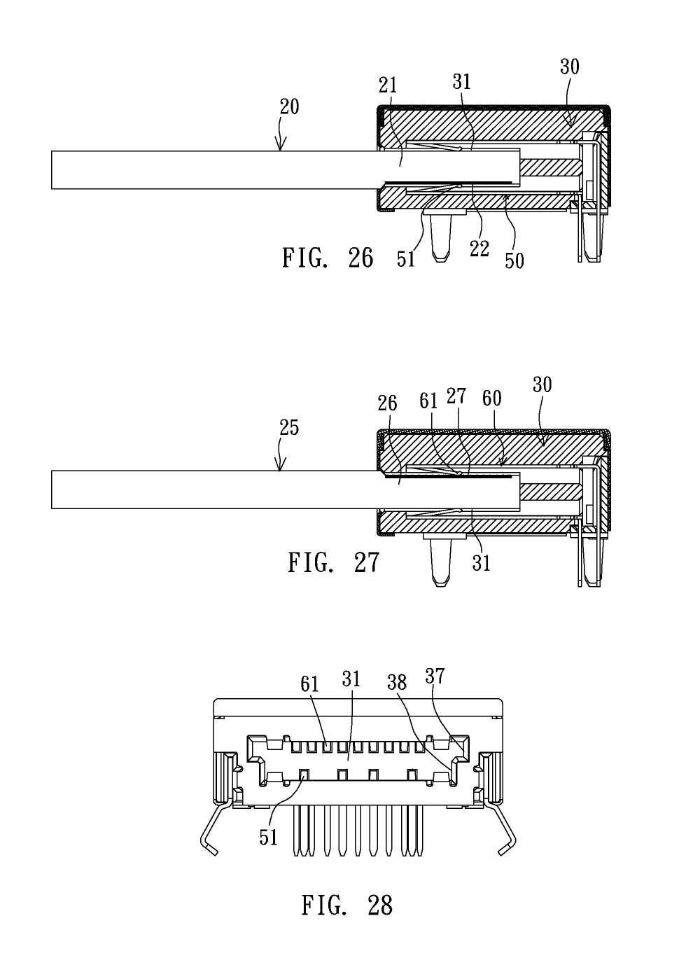

According to the above-mentioned structure, as shown in FIG. 26, when the connection terminals 22 of the plug 21 of the storage card 20 are downwardly inserted into the connection slot 31, the four connection terminals 22 are electrically connected to the lower contacts 51 of the first lower terminal 50. As shown in FIG. 27, when the connection terminals 27 of the plug 26 of another storage card 25 are upwardly inserted into the connection slot 31, the nine connection terminals 72 are electrically connected to the upper contacts 61 of the nine first upper terminals 60. Thus, the storage cards 20 and 25 having two different connection interfaces may be inserted for the connection, so that the usage of the invention may be diversified.

As shown in FIG. 28, the seventh embodiment of the invention is almost the same as the sixth embodiment except that the connection slot 31 of this embodiment has upper and lower sections 37 and 38 having different widths so that two plugs of storage cards having different widths and thicknesses may be connected to the connection slot.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A storage card socket for a bidirectional electrical connection, the socket comprising:
a plastic base;
a connection slot, which is disposed at a front end of the plastic base, has an inserting port and opposite top and bottom surfaces, and may be connected to a plug of a storage card;
a metal casing, which covers the plastic base and has an opening corresponding to the inserting port of the connection slot;
at least one row of lower contacts separately arranged in the connection slot, wherein the lower contacts are directed to the top surface of the connection slot; and
at least one row of upper contacts separately arranged in the connection slot, wherein the upper contacts are directed to the bottom surface of the connection slot.

2. The storage card socket according to claim 1, wherein the connection slot and the plastic base are integrally formed.

3. The storage card socket according to claim 1, wherein the at least one row of upper contacts and the at least one row of lower contacts have the same connection interface, and the number of the row of the upper contacts corresponds to the number of the row of the lower contacts.

4. The storage card socket according to claim 1, wherein each of the lower contacts and each of the upper contacts are connected to pin portions extending out of the plastic base.

5. The storage card socket according to claim 3, further comprising at least one circuit board, each of the lower contacts and each of the upper contacts are electrically connected to the at least one circuit board, the one row of the upper contacts and the one row of the lower contacts corresponding to the one row of the upper contacts make each of the lower contacts sequentially be electrically connected to one of the oppositely arranged upper contacts through traces of the at least one circuit board, and share one pin portion extending out of the plastic base, so that a first one of the lower contacts is electrically connected to a last one of the upper contacts, and a second one of the lower contacts is electrically connected to a last second one of the upper contacts.

6. The storage card socket according to claim 1, wherein the at least one row of lower contacts are formed on at least one row of lower terminals, each of the lower terminals has the lower contact, an extension and a fixing portion, the extension extends to the connection slot, the lower contact is connected to the extension, the at least one row of upper contacts are formed on at least one row of upper terminals, each of the upper terminals has the upper contact, an extension and a fixing portion, the extension extends to the connection slot, and the upper contact is connected to the extension.

7. The storage card socket according to claim 6, wherein the lower contact of the lower terminal projects beyond a plate surface of the extension toward the top surface, and is elastically moved toward the bottom surface when being connected to the plug of the storage card, and the upper contact of the upper terminal projects beyond a plate surface of the extension toward the bottom surface, and is elastically moved when being connected to the plug of the storage card.

8. The storage card socket according to claim 6, wherein the fixing portion of each of the lower terminals and the fixing portion of each of the upper terminals are fixed to the plastic base.

9. The storage card socket according to claim 6, wherein the at least one row of lower terminals comprise one row of first lower terminals and one row of second lower terminals, contacts of the second lower terminals are disposed in front of contacts of the first lower terminals, the at least one row of upper terminals comprise one row of first upper terminals and one row of second upper terminals, contacts of the second upper terminals are disposed in front of contacts of the first upper terminals, the number of the one row of the first upper terminals corresponds to the number of the one row of the first lower terminals, and the number of the one row of the second upper terminals corresponds to the number of the one row of the second lower terminals.

10. The storage card socket according to claim 5, wherein the at least one circuit board is an upper circuit board, and the storage card socket further comprises a lower circuit board, each of the lower contacts is electrically connected to the lower circuit board, and each of the upper contacts is electrically connected to the upper circuit board.

11. The storage card socket according to claim 10, wherein the at least one row of lower contacts are formed on one row of lower terminals and one row of first circuits, the lower terminal has the lower contact, the first circuit has the lower contact disposed in front of the lower contact of the lower terminal, the at least one row of upper contacts are formed on one row of upper terminals and one row of second circuits, the upper terminal has the upper contact, and the second circuit has the upper contact disposed in front of the upper contact of the upper terminal.

12. The storage card socket according to claim 1, wherein the at least one row of upper contacts and the at least one row of lower contacts have different connection interfaces.

13. The storage card socket according to claim 6, wherein two rows of separately arranged terminal slots are respectively disposed above and below the connection slot of the plastic base, a plate surface of the extension of the lower terminal is in surface contact with the terminal slot below the connection slot, one end of the lower contact is connected to the extension, gradually projects beyond the plate surface of the extension from front to rear and extends to the other end being open and serving as a free end, a plate surface of the extension of the upper terminal is in surface contact with the terminal slot below the connection slot, and one end of the upper contact is connected to the extension, gradually projects beyond the plate surface of the extension from front to rear and extends to the other end being open and serving as a free end.

14. The storage card socket according to claim 13, wherein the lower contact of the lower terminal is prodded to project beyond the plate surface of the extension, the plate surface of the extension of the lower terminal has a notch larger than a plate surface of the lower contact, and the lower contact is entirely disposed within the notch when being flattened toward the plate surface of the extension.

15. The storage card socket according to claim 13, wherein the upper contact of the upper terminal is prodded to project beyond the plate surface of the extension.

16. The storage card socket according to claim 12, wherein the connection slot has upper and lower sections having different widths so that two plugs of storage cards having different widths and thicknesses may be connected to the connection slot.
